(19) United States
(12) Patent Application Publication
(10) Pub. No.: US 2021/0185996 A1
(43) Pub. Date: Jun. 24, 2021

(54) FISHING ASSIST SYSTEM

(71) Applicant: SMARTLURE CORPORATION, Sapporo-shi, Hokkaido (JP)

(72) Inventor: Yuki Okamura, Sapporo-shi, Hokkaido (JP)

(73) Assignee: SMARTLURE CORPORATION, Sapporo-shi, Hokkaido (JP)

(21) Appl. No.: 16/757,828

(22) PCT Filed: Oct. 24, 2018
(86) PCT No.: PCT/JP2018/039460

§ 371 Date: Apr. 21, 2020

(30) Foreign Application Priority Data
Oct. 25, 2017 (JP) 2017-206321

(51) Int. Cl. A01K 97/12; A01K 85/00; A01K 99/00

(52) U.S. Cl. CPC A01K 97/125; A01K 99/00; A01K 85/00

(57) ABSTRACT

Provided is a fishing assist system configured to present various types of information on a catch to a fisher in association with actual catches, to thereby enable even an inexperienced fisher to easily acquire a fishing method leading to a catch. The fishing assist system includes: a fishing information distribution server configured to collect various types of fishing information from a fisher being a user and to distribute the fishing assist information to a user; a sensing device configured to be cast into water together with a rig to collect various types of fishing information; and a fishing assist program configured to enable communication between the user and the fishing information distribution server.

### TECHNICAL FIELD

The following disclosure relates to a fishing assist system, in leisure fishing, such as bait fishing and lure fishing, which is configured to present to a fisher a fishing method leading to a catch.

### BACKGROUND ART

In leisure fishing, such as bait fishing and lure fishing, it is not possible to expect a catch just by simply casting a rig into the water. In order to reliably expect a catch, it is required to accurately grasp the ecology of a fish, cast the rig, for example, an appropriate bait or lure, into the water in accordance with the grasped details, and attract the fish to the rig. In lure fishing and some bait fishing, the movement of the rig in the water is an important factor for attracting the fish, and differences in how the fishing rod is moved and how the reel winds up the fishing line also greatly affect the catch.

Those factors relating to the catch are correlated, and when one of those factors is wrong, it is more difficult to lead to the catch even when the other factors are appropriate. For that reason, a fisher who does not catch a fish may find it difficult to grasp which factor is inappropriate. Moreover, each fisher relies on his or her own experience when determining those factors, and therefore it is impossible in the first place for an inexperienced fisher to make an appropriate determination.

In Patent Literature 1, there is proposed an underwater information providing system configured to acquire, by using an underwater information detection device cast into the water, underwater information including school of fish information, information on a shape of the water bottom, and water temperature information, and to share the underwater information with an unspecified number of fishers via the Internet by using measurement position information as a search key.

### CITATION LIST

### Patent Literature

[PTL 1] JP 2002-189078 A

### DISCLOSURE OF THE INVENTION

### Problems to be Slved by the Invention

However, the system described in Patent Literature 1 tells the fisher about the latest information on whether or not a fish is at a specific position and, when there is a fish, tells the fisher about where the fish is between the water surface and the water bottom, but the system does not tell the fisher about the appropriateness of the many factors relating to a catch. Therefore, there is a problem in that, even when the fisher uses the system, it is not possible for the fisher to verify whether or not the rig cast into the water and how the rig is to be moved are appropriate in relation to the ecology of the fish, and as a result, it is difficult to lead to a catch.

### Means for Solving the Problems

The following disclosure has been made in view of such a problem, and it is an object of this disclosure to provide a fishing assist system configured to present various types of information on a catch to a fisher in association with actual catches, to thereby enable even an inexperienced fisher to easily acquire a fishing method leading to a catch.

The fishing assist system of this disclosure includes: a fishing information distribution server configured to collect various types of fishing information from a fisher being a user and to distribute the fishing assist information to a user; a sensing device configured to be cast into water together with a rig to collect various types of fishing information; and a fishing assist program configured to enable communication between the user and the fishing information distribution server.

The fishing information distribution server includes: a processing storing unit configured to receive, from a user via a network, fishing information including catch information, position information indicating a fishing point, and environment information at the fishing point, to store the received fishing information in a history database; a request reception unit configured to receive an assist request including the position information and the environment information from a user; an assist information generation unit configured to extract fishing information corresponding to the assist request from the history database to generate fishing assist information; and an information distribution unit configured to distribute the fishing assist information to the user who has transmitted the assist request.

Further, a sensing device to be used in the fishing assist system includes: a sensor including one or a plurality of sensors among an acceleration sensor, a gyro sensor, a geomagnetic sensor, and a pressure sensor; a storage unit configured to record time-series change information on a time-series change of an output signal of the sensor exhibited when the sensing device enters the water; and a communication unit configured to externally transmit the time-series change information.

Further, a fishing assist program to be used in the fishing assist system includes: information providing means for transmitting, to a fishing information distribution server configured to distribute fishing assist information, fishing information including catch information, date and time information, and position information indicating a fishing point; assist request transmission means for transmitting an assist request including the position information and the date and time information to the fishing information distribution server; and assist information processing means for receiving, from the fishing information distribution server, fishing assist information corresponding to the assist request, and presenting the fishing assist information to a user via a user interface.

### Effects of the Invention

According to this disclosure, various types of information corresponding to a place or an environment at which the user is fishing, for example, information on fish species for which there is a track record of a catch, a selection of the rig to be cast into the water, and how to move the rig in the water, can be presented to the user in association with actual catches. As a result, even an inexperienced fisher can easily acquire knowledge of a fishing method leading to a catch, and can thus easily experience the joy of leisure fishing.

### BRIEF DESCRIPTION OF THE DRAWINGS

FIG. 1 is a schematic diagram for illustrating an example of a leisure fishing assist system according to this disclosure.

FIG. 2 is a diagram for illustrating an example of the structure of fishing information to be uploaded to an information distribution server.

FIG. 3 is a diagram for illustrating an example of the structure of an assist request uploaded to the information distribution server and the structure of fishing assist information to be downloaded from the information distribution server.

FIG. 4 is a schematic diagram for illustrating an example of acquiring environment information and item operation information from a lure.

FIG. 5 is a block diagram for illustrating an example of a configuration of a sensor module mounted on a lure.

FIG. 6 is a block diagram for illustrating an example of a configuration of an information terminal held by a user.

FIG. 7 is a diagram for illustrating an example of a screen for inputting fishing information on a display of the information terminal.

FIG. 8 is a block diagram for illustrating an example of a configuration of the information distribution server.

FIG. 9 is a diagram for illustrating an example of a screen for transmitting an assist request on the display of the information terminal.

FIG. 10 is a diagram for illustrating an example of a screen for displaying fishing assist information on the display of the information terminal.

### MODE FOR CARRYING OUT THE INVENTION

A leisure fishing assist system of this disclosure is now described in detail with reference to the accompanying drawings.

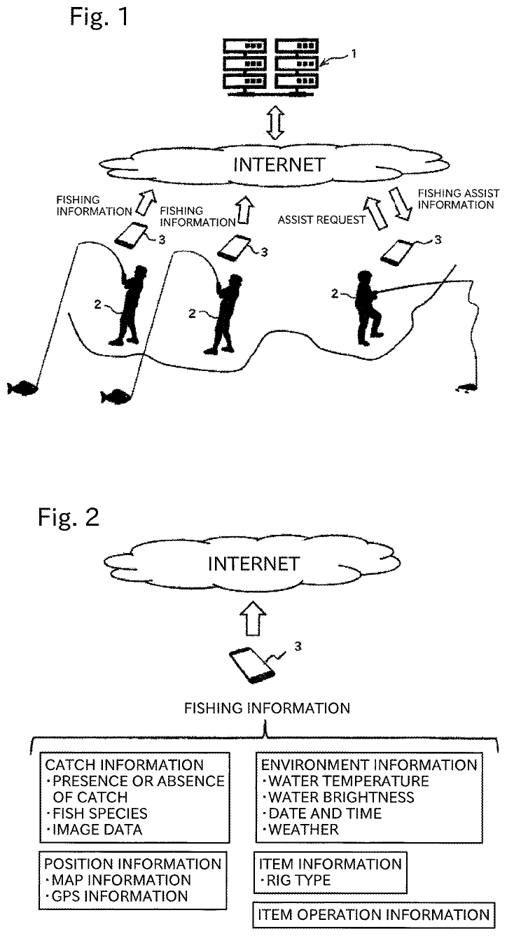

First, an outline of the assist system of this disclosure is described. As illustrated in FIG. 1, the assist system includes a fishing information distribution server (hereinafter referred to as “information distribution server”) 1 connected to the Internet. The information distribution server 1 is configured to collect various types of fishing information, which includes catch information, from a fisher (hereinafter referred to as “user”) 2 via the Internet, to generate in response to an assist request transmitted from the user 2 fishing assist information for increasing the probability of a catch, and to distribute the generated fishing assist information to the user 2. Each user 2 holds an information terminal 3 connected to the Internet, uploads the fishing information from the information terminal to the information distribution server 1, transmits an assist request to the information distribution server 1, and downloads the fishing assist information from the information distribution server 1.

It is required that the information terminal 3 include a function of connecting to the Internet, an interface for inputting fishing information, and a display for displaying the fishing assist information. The information terminal 3 may be a portable terminal, for example, a commercially available tablet or smartphone, onto which a fishing assist program (hereinafter referred to as “assist program”) for using the assist system of this disclosure may be installed.

FIG. 2 is a schematic diagram for illustrating the types of fishing information to be uploaded from the information terminal 3 to the information distribution server 1 via the Internet. The fishing information includes catch information on a caught fish, position information on a place at which the user performed fishing (hereinafter referred to as “fishing point”), and environment information on the fishing point. The fishing information may include item information on a rig used by the user, item operation information on movement of a rig cast into the water, and the like. The item information may include information on a fishing rod, a reel, and a fishing line used by the user.

The catch information includes information on the presence or absence of a catch, and when there is a catch, information on the caught fish species and its size. The assist program controls the information terminal 3 to present to the user a screen for inputting the catch information. When the information terminal 3 includes a camera, the camera may be used to include image data in the catch information.

The position information is information for identifying the position at which the user 2 performs fishing, that is, the fishing point. The assist program controls the information terminal 3 to present to the user a screen for inputting the position information. The position information may be manually input by the user 2 to the information terminal by using map information displayed on the information terminal 3, or the assist program may be configured to automatically acquire the position information by using a GPS function included in a portable terminal such as a smartphone or a tablet.

The environment information is information for indexing an activity of a fish behavior at the fishing point (hereinafter referred to as “activity degree”), and is information for directly or indirectly grasping, for example, a water temperature, a water brightness, or a salt concentration in the water. Underwater environment information, such as the water temperature and the water brightness, is important information indicating the activity degree of the fish behavior. For example, through casting a measuring instrument including a built-in temperature sensor or a brightness sensor into the water, the temperature or the brightness can be directly measured and grasped. At that time, it is preferred that the water temperature and brightness corresponding to the water depth be able to be measured, because this enables the location of fish having a high activity degree to be estimated.

Even in a case where underwater environment information such as water temperature and water brightness cannot be measured directly, when there is date and time information, an average temperature at the fishing point, a sunrise and sunset time, and a moonrise and moonset time can be grasped by combining the date and time information with the position information, to thereby enable the water temperature and water brightness relating to that date and time to be indirectly estimated. When there is weather information on the fishing point in addition to the date and time information, it is possible to estimate the water temperature and the brightness of the water surface in more detail in view of the weather conditions. Therefore, the date and time information and the weather information can be treated as the environment information.

Moreover, the date and time information is information required for referring to the tides and the moon phase at the fishing point. In this sense, the date and time information can be treated as environment information.

When the environment information is acquired by casting into the water a measuring instrument including a built-in temperature sensor or brightness sensor, measurement data is transmitted wirelessly or by wire from the measuring instrument to the information terminal 3, and the measurement data can be uploaded to the information distribution server 1 via the assist program. The timing to transmit the measurement data from the measuring instrument to the information terminal 3 may be the time when the measuring instrument is present in the water, immediately after the measuring instrument is pulled up from the water, or after a predetermined time has elapsed from the time at which the measuring instrument is pulled up from the water. Further, the date and time information may be directly input to the assist program by the user 2 using a user interface of the information terminal 3, or the assist program may automatically acquire the date and time information from the information terminal 3. The weather information may be automatically acquired from a weather information site, for example, on the Internet by the assist program based on the position information and the date and time information.

The item information is information on the rig cast into the water to be used by the user 2. In the case of bait fishing, the type of bait to be used is also included in the item information. As the item information, the type of item used by each user 2 can be directly input to the information terminal 3 and uploaded to the information distribution server 1. The assist program presents a screen for inputting the item information to the user. Regarding the rig, a tag storing an identification code unique to each item may be attached to each item in advance, and the information terminal 3 may receive the identification code from the tag.

The item operation information is information on the movement of the rig in the water. In order to acquire the item operation information, in the assist system of this disclosure, a sensing device including one or a plurality of sensors among a built-in acceleration sensor, a gyro sensor, and a geomagnetic sensor is cast into the water together with the rig. For example, in the case of lure fishing, the lure itself as the rig can be integrated with the sensing device. That is, one or a plurality of sensors among an acceleration sensor, a gyro sensor, a geomagnetic sensor, and a pressure sensor are built in the lure, and the item operation information is grasped from changes in output signals from those sensors. The movement of the rig in the water is an important factor in attracting a fish to the rig. When the movement of the rig in the water can be grasped as the item operation information, it is possible to find out how to move the rig in order to catch a fish in relation to the position information and the environment information. In addition, a reel winding speed (hereinafter referred to as “retrieve speed”) and the manner in which the rod is moved have a large effect on the movement of the rig in the water. Recording and analyzing the change in an output signal of an acceleration sensor, for example, enables the retrieve speed of each user 2 and how each user is moving the rod to be grasped.

The item information and the item operation information are different from the position information and the environment information, and are information on actions determined by the user 2. For example, when there are a plurality of users 2 fishing at the same place, the position information and the environment information are substantially common to the plurality of users 2, but the item information and the item operation information are different for each user 2. This difference is considered to have an influence on the catch information. In the case of lure fishing in particular, unlike bait fishing, lure selection and the movement of the lure in the water have a large impact on whether or not a fish is caught. It is very important that the item information and the item operation information be grasped when fishing assist information leading to a catch is provided to the user.

It is preferred that the fishing information to be uploaded to the information distribution server 1 be uploaded from the information terminal 3 to the information distribution server 1 every time the user 2 pulls up the cast rig and sensing device. In addition, it is preferred that the fishing information be uploaded not only for cases in which the cast led to a catch, but also for cases in which the cast did not lead to a catch. That is, through uploading the catch information, the position information, the environment information, the item information, and the item operation information in association with each other each time casting is performed, integrated information on what types of fish have been caught when the various pieces of item information and item operation information are combined with the various pieces of position information and environment information can be obtained and accumulated in the information distribution server 1.

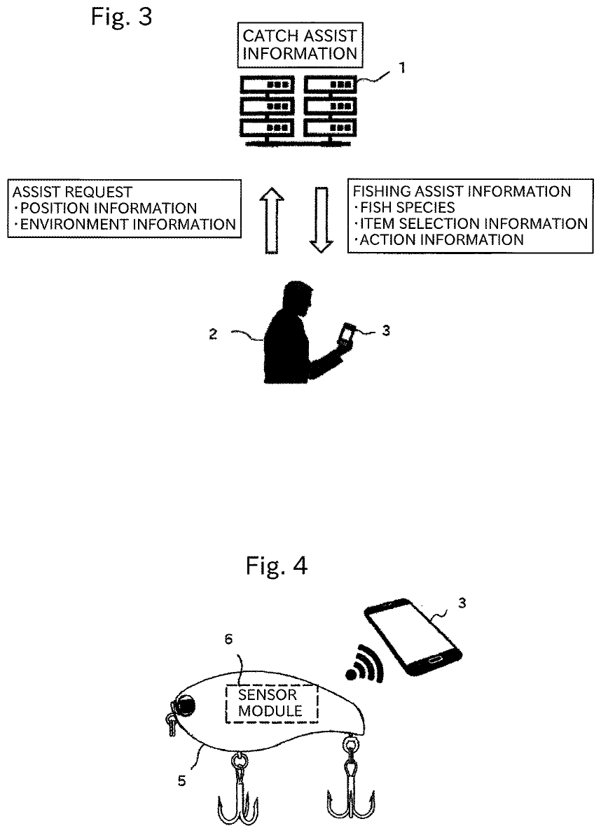

FIG. 3 is a diagram for illustrating an outline of the fishing assist information to be downloaded from the information distribution server 1 to the information terminal 3 of the user 2. The information distribution server 1 receives an assist request transmitted from the information terminal 3 of the user 2, and uses the accumulated fishing information to create fishing assist information corresponding to the content of the assist request. When the user transmits the assist request, the user 2 includes in the assist request the position information and the environment information at the fishing point. As the fishing assist information, the information distribution server 1 extracts, from among the accumulated fishing information, the fishing information which corresponds to the position information and the environment information included in the assist request and in which a catch is recognized.

The fishing assist information includes fish species information corresponding to the fishing point, item selection information on the rig selection, and action information on how to move the rig in the water. This fishing assist information is obtained by processing fishing information in which a catch is recognized, and therefore the fish species information, the item selection information, and the action information are useful for a user 2 who does not know the appropriate fishing method at the fishing point. The user 2 can improve his or her rig selection and how he or she moves the rig in the water based on the fishing assist information, to thereby improve the probability of a catch.

Next, there is described an example of applying the fishing assist system of this disclosure to lure fishing.

FIG. 4 is a diagram for illustrating a case in which the sensing device is integrated with a lure 5 serving as a rig, and a sensor module 6 is built in the lure 5. The sensor module 6 is a unit formed by mounting various electronic devices on a circuit board. The sensor module 6 is housed inside the lure 5, which is waterproofed. When the lure 5 is cast into the water, various sensors mounted on the sensor module 6 measure and record the movement of the lure 5 in the water, the water temperature, and the brightness in the water. When the lure 5 is pulled out of the water and held over the information terminal 3, the measurement data of the various sensors can be wirelessly transmitted from the sensor module 6 to the information terminal as the environment information or the item operation information.

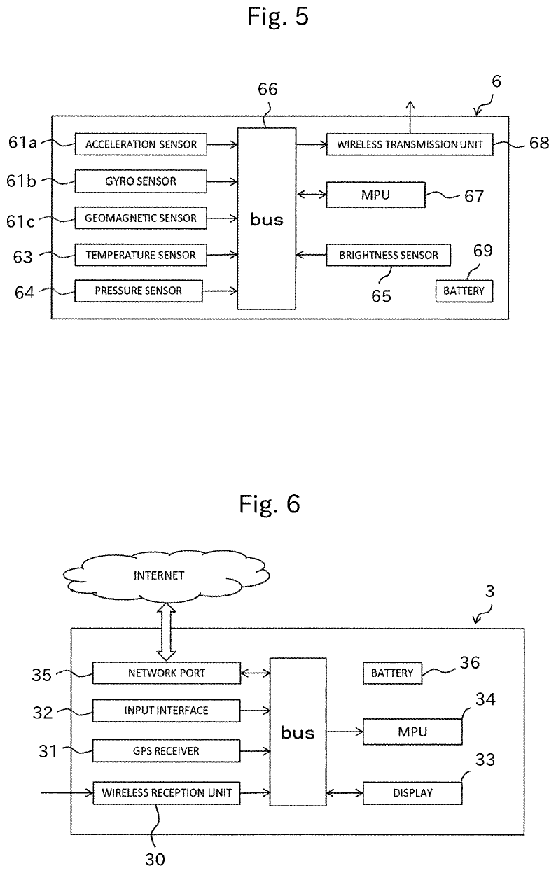

FIG. 5 is a block diagram for illustrating the configuration of the sensor module 6 built in the lure 5. The sensor module 6 includes an acceleration sensor 61a, a gyro sensor 61b, a geomagnetic sensor 61c, a temperature sensor 63, a pressure sensor 64, and a brightness sensor 65. The output signals of those sensors are collected at a predetermined sampling cycle, and input to an MPU 67 as a one-chip microcomputer via a bus 66. The output signals of the sensors input to the MPU 67 are subjected to digital conversion processing and then held in a memory (not shown) arranged in the sensor module 6. The sensor module 6 includes a wireless communication unit 68. The output signals of the sensors processed and recorded by the MPU 67 are transmitted to the information terminal 3 held by the user 2. A battery 66 is mounted on the circuit board. The battery 69 is configured to supply power to each of the sensors 61 to 65, the MPU 67, and the wireless transmission unit 68.

The MPU 67 is configured to control the operation of each sensor, and to collect, and record in the memory, a time-series change of the output signal of each sensor at a predetermined sampling cycle during the period from when the lure 5 cast into the water lands on the water until the lure 5 leaves the water. Various types of level sensors, for example, commercially available electrode sensors or capacitance sensors, may be used to detect the lure 5 landing on the water and leaving the water. The output signals of those level sensors change when the electrode portion is immersed in water, and therefore the MPU 67 can determine whether the lure 5 has landed on the water or left the water based on whether or not the output signal has exceeded a predetermined threshold value.

The output signals of the acceleration sensor 61a, the gyro sensor 61b, and the geomagnetic sensor 61c mounted on the sensor module 6 indicate an action by the lure 5 in the water, and correspond to the item operation information described above. Normally, the lure 5 oscillates in a jiggling manner in the water in accordance with the retrieve speed. However, the retrieve speed and the oscillation frequency of the lure 5 in the water can be grasped by analyzing the output signal of the acceleration sensor 61a, the gyro sensor 61b, or the geomagnetic sensor 61c. Further, when the lure 5 is oscillating in a jiggling manner in the water, the water pressure acting on the lure 5 changes, and hence a change also occurs in the output signal of the pressure sensor 64 in accordance with the oscillation. Therefore, the retrieve speed and the oscillation frequency of the lure 5 in the water can also be grasped by analyzing the output signal of the pressure sensor 64.

Further, the output signal of the pressure sensor 64 indicates the water pressure acting on the lure 5 in the water. Therefore, the time-series change of the output signal of the pressure sensor 64 collected for a predetermined sampling time indicates the change in the water depth of the lure 5 in the water. Therefore, it is possible to three-dimensionally grasp the movement of the lure 5 in the water by analyzing the time-series changes of the output signals of the acceleration sensor 61a, the gyro sensor 61b, the geomagnetic sensor 61c, and the pressure sensor 64.

Moreover, a change in the water temperature corresponding to the water depth can be grasped by analyzing the change in the output signal of the temperature sensor 63 in association with the change in the output signal of the pressure sensor 64. In a similar way, a change in the water brightness corresponding to the water depth can be grasped by analyzing the change in the output signal of the brightness sensor 65 in association with the change in the output signal of the pressure sensor 64. That is, changes in the output signals of the water temperature sensor 63, the pressure sensor 64, and the brightness sensor 65 indicate changes in the water temperature and the brightness corresponding to the water depth, and correspond to the underwater environment information in this disclosure.

FIG. 6 is a block diagram for illustrating the configuration of the information terminal 3 held by the user 2. The information terminal 3 includes a wireless reception unit 30 configured to receive information transmitted from the sensor module 6 of the lure 5, a GPS receiver 31 configured to generate the position information, an input interface 32 such as a keyboard or a camera, a display 33 to be used for inputting and displaying various types of information, and an MPU 34 being a one-chip microcomputer configured to control the wireless reception unit 30, the GPS receiver 31, the input interface 32, and the display 33.

An assist program for using the assist system of this disclosure is installed in the information terminal 3. The assist program is configured to present to the user a screen for inputting the catch information, the position information, the environment information, and the item information. The information terminal 3 also includes a network port 35 for connecting the information terminal 3 to the Internet, which enables various types of information to be uploaded or downloaded to and from the information distribution server 1 via the Internet. Moreover, the information terminal 3 includes a battery 36 configured to supply power to each built-in device.

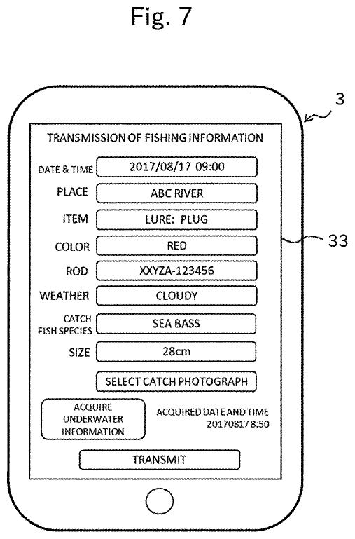

FIG. 7 is a diagram for illustrating an example of a screen for inputting fishing information to be displayed on the display 33 of the information terminal 3 when the fishing information is uploaded from the information terminal 3 to the information distribution server 1. The input screen includes input fields for the species and the size of the caught fish as catch information, and a button for moving to a screen for selecting a photograph held in the information terminal 3 in association with the catch. The input screen also includes an input field for inputting a place being position information on the fishing point. The information on the place may be automatically input based on the current position information held in the information terminal 3. Moreover, the input screen includes fields for inputting the date and time information, and input fields for information on the items used in connection with the catch, specifically, the type of the lure 5, the color of the lure 5, and the type of the fishing rod. In addition, as a supplement to the environment information, an input field for the weather at the time of the catch is arranged.

The input screen includes an information acquisition button for acquiring various types of information in the water from the sensor module 6 of the lure 5, specifically, the underwater environment information and the item operation information. When the lure 5 is pulled out of the water and the information acquisition button is pressed in a state in which the lure and the information terminal are within a predetermined distance from each other, the measurement information of the various sensors held in the memory of the sensor module is transferred to the information terminal, and held in the information terminal in association with the manually input position information, item information, and the like. In the example illustrated in FIG. 7, when the information acquisition from the lure 5 is performed normally, the acquisition date and time of the information is displayed.

Then, when a transmission button arranged on the fishing information input screen is pressed, the catch information, the position information, the item information, the underwater environment information, and the item operation information associated by the input screen are uploaded from the information terminal 3 to the information distribution server 1 via the Internet.

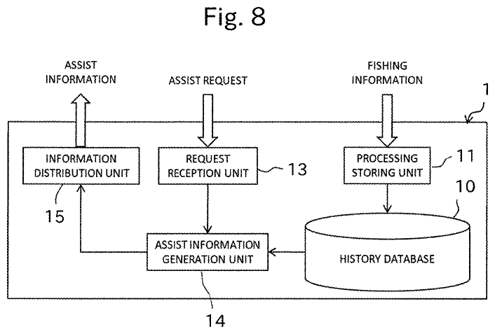

FIG. 8 is a diagram for illustrating the configuration of the information distribution server 1. The information distribution server 1 is a computer connected to the Internet, and includes a history database 10 configured to accumulate the fishing information uploaded from the information terminal 3 onto the Internet. The fishing information uploaded to the information distribution server 1 is subjected to certain processing by a processing storing unit 11, and then recorded in the history database 10.

The processing storing unit 11 is configured to generate water temperature/water depth distribution information and action information by using the environment information and the item operation information included in the fishing information, to store the generated water temperature/water depth distribution information in the history database 10 in association with the position information, the catch information, and the item information. The action information includes various types of information, such as the water temperature and water brightness at which fish have a high activity degree, the optimal retrieve speed of the lure 5, the optimal underwater oscillation frequency of the lure 5, and the manner of moving the fishing rod.

The measurement data of the temperature sensor 63 and the pressure sensor 64 of the lure 5 is a group of measurement values collected at a predetermined sampling cycle. Therefore, the water temperature/water depth distribution information can be generated by processing pieces of the measurement data in combination.

The retrieve speed of the lure 5, the oscillation frequency of the lure 5 in the water, and the manner of moving the fishing rod can be clarified by analyzing the measurement data of the acceleration sensor 61a, the gyro sensor 61b, and the geomagnetic sensor 61c of the lure 3. The manner of moving the fishing rod is a known pattern relating to the manner in which the fishing rod is moved, and includes, for example, twitching in which the tip of the fishing rod is lightly moved in a jiggling manner, and jerking in which the lure is violently moved by moving the rod in a powerful and rapid manner.

Meanwhile, a user 2 who wants to receive fishing assist information from the information distribution server 1 uses the lure 5 mounted with the sensor module 6 to collect the underwater environment information, that is, data relating to the water temperature, the water depth, and the brightness, at the fishing point where the user 2 is, and uploads the environment information or the position information together with the assist request to the information distribution server 1.

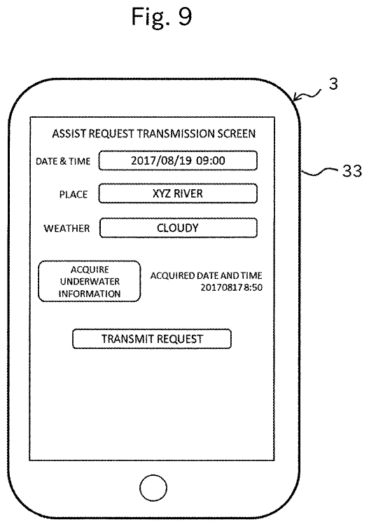

FIG. 9 is a diagram of an example of an assist request transmission screen displayed on the display 33 of the information terminal 3 when the assist request is uploaded from the information terminal 3 to the information distribution server 1. The transmission screen includes an input field for the date and time information, an input field for a place as position information on the fishing point, and an input field for the weather. The transmission screen also includes an information acquisition button for acquiring the underwater environment information from the sensor module 6 of the lure 5. A user who does not own a lure 5 including a built-in sensor module 6 may transmit an assist request by inputting only the position information and the date and time information.

When the transmission button arranged on the assist request transmission screen is pressed, the position information, the underwater environment information, and the like associated through the transmission screen are uploaded from the information terminal 3 to the information distribution server 1 via the Internet.

As illustrated in FIG. 8, the uploaded assist request is processed by a request reception unit 13. The request reception unit 13 is configured to process the environment information attached to the assist request to create water temperature/water depth distribution data and water brightness/water depth distribution data, and to hold the created data together with the assist request.

The assist request held in the request reception unit 13 is read by an assist information generation unit 14. The assist information generation unit 14 is configured to refer to the fishing information held in the history database 10 to extract, as the fishing assist information, fishing information matching the position information or the environment information attached to the assist request. When a plurality of pieces of fishing information are extracted from the history database 10, the assist information generation unit 14 refers to the date and time information attached to the assist request and extracts the fishing information having the closest date and time as the fishing assist information.

The assist information generation unit 14 extracts, as the fishing assist information, fishing information in which there is a catch and that has position information close to the position information attached to the assist request. When the assist request includes the above-mentioned environment information, the assist information generation unit 14 extracts, as the fishing assist information, fishing information in which there is a catch and that has environment information similar to the environment information included in the assist request. For example, the assist information generation unit 14 compares the water temperature/water depth distribution data created by the request reception unit 13 with the water temperature/water depth distribution data of each piece of fishing information held in the history database 10, and extracts, as the fishing assist information, fishing information having similar water temperature/water depth distribution data.

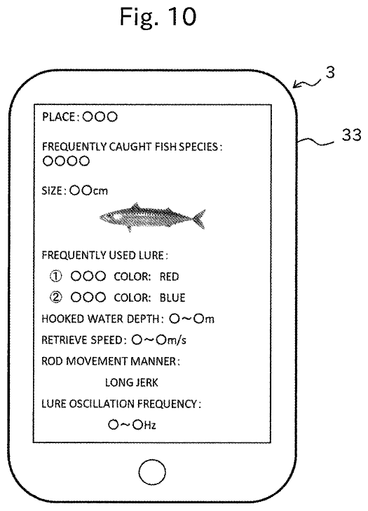

The extracted fishing assist information is transferred to an information distribution unit 15 and distributed to the information terminal 3 of the user 2 who has transmitted the assist request. FIG. 10 is a diagram of an example of a screen for displaying the fishing assist information on the display 33 of the information terminal 3 of the user 2. The displayed fishing assist information includes information on the fish species for which there is a catch track record at the fishing point and under the environment information shown in the assist request, item selection information on the lure used at that time, the water depth at which the lure hooked the fish, the lure retrieve speed, the lure oscillation frequency in the water, and action information on the manner of moving the fishing rod.

The fishing assist information displayed on the information terminal 3 is based on a specific environment, namely, a specific water temperature and water brightness, and can be said to reflect the ecology of the fish. For this reason, when the user 2 selects the lure to be used by referring to the presented item selection information, and causes the lure to move in the water by referring to the presented action information, it is possible to create a situation that is almost the same as that for past fishing information for which there is a catch track record accumulated in the fishing information distribution server, and the type of the lure to be cast into the water and the manner of moving the lure can be made appropriate in relation to the ecology of the fish.

That is, a user 2 who has received the fishing assist information from the information distribution server 1 can easily grasp the optimal lure selection for the fishing point and how to move the lure in the water, and even an inexperienced fisher can increase the probability of a catch.

Further, fishing assist information in which there is not a catch is also held in the history database 10 of the information distribution server 1. Therefore, through referring to all of the fishing information held in the history database 10, it becomes possible to analyze the type of lure that easily leads to a catch in relation to the water temperature, the water depth, and the brightness in the water, and a large amount of data important for lure manufacturers can be collected from many users.

In the example described above with reference to the drawings, the assist system of this disclosure is applied to lure fishing. However, the assist system of this disclosure can be applied to bait fishing as well.

1. A fishing assist system, comprising:
a sensing device configured to be cast into water together with a rig, and to generate item operation information on a movement of the rig in the water by a built-in sensor;
an information terminal configured to collect catch information, position information indicating a fishing point, environment information at the fishing point, and item information on the rig cast to the water and to transmit the catch information, the position information, the environment information, and the item information and the item operation information received from the sensing device to a network as fishing information; and
a fishing information distribution server configured to receive to accumulate the fishing information via the network,
the information terminal being configured to transmit an assist request including the position information and the environment information to the fishing information distribution server,
the fishing information distribution server being configured to generate fishing assist information including item selection information on the rig selection and action information on how to move the rig in the water based on the fishing information corresponding to the assist request, and to distribute the fishing assist information to the information terminal that has transmitted the assist request.

2. A fishing information distribution server to be used in the fishing assist system of claim 1, the fishing information distribution server comprising:
a processing storing unit configured to receive, from a user via a network, fishing information including catch information, position information indicating a fishing point, environment information at the fishing point, item information on a rig cast to a water, and item operation information on the movement of the rig in the water, to generate action information on how to move the rig in the water by using the item operation information, and to store the action information in a history database in association with the catch information, the position information and the item information;
a request reception unit configured to receive an assist request including the position information and the environment information from a user;
an assist information generation unit configured to extract fishing information corresponding to the assist request from the history database to generate fishing assist information including item selection information on the rig selection and the action information; and
an information distribution unit configured to distribute the fishing assist information to the user who has transmitted the assist request.

3. The fishing information distribution server according to claim 2, wherein the environment information includes underwater environment information on a water temperature and a water brightness at the fishing point.

4. The fishing information distribution server according to claim 3,
wherein the assist request includes the underwater environment information, and
wherein the assist information generation unit is configured to extract fishing information corresponding to the underwater environment information from the history database.

5-8. (canceled)

9. The fishing information distribution server according to claim 2, wherein the fishing information includes date and time information.

10-15. (canceled)

16. A fishing assist system according to claim 1, wherein the action information includes a retrieve speed of the rig and the manner of moving the fishing rod.

17. A fishing assist system according to claim 1, wherein the fishing information includes a combination of the position information, the environment information, the item information, and the item operation information for cases in which the cast did not lead to a catch.

18. The fishing information distribution server according to claim 2, wherein the action information includes a retrieve speed of the rig and the manner of moving the fishing rod.

19. The fishing information distribution server according to claim 2, wherein the fishing information includes a combination of the position information, the environment information, the item information, and the item operation information for cases in which the cast did not lead to a catch.
